(19) United States
(12) Patent Application Publication
(10) Pub. No.: US 2021/0298063 A1
(43) Pub. Date: Sep. 23, 2021

(54) JOINT RESOURCE ASSIGNMENT FOR A USER EQUIPMENT (UE) AND A RELAY UE FOR UPLINK AND SIDELINK TRANSMISSIONS

(71) Applicant: QUALCOMM Incorporated, San Diego, CA (US)

(72) Inventors: Jelena DAMNJANOVIC, Del Mar, CA (US); Tao LUO, San Diego, CA (US); Juan MONTOJO, San Diego, CA (US); Sony AKKARAKARAN, Poway, CA (US); Aleksandar DAMNJANOVIC, Del Mar, CA (US); Olufunmilola Omolade AWONIYI-OTERI, San Diego, CA (US)

(21) Appl. No.: 17/198,110

(22) Filed: Mar. 10, 2021

Related U.S. Application Data
(60) Provisional application No. 62/991,509, filed on Mar. 18, 2020.

(51) Int. Cl. H04W 72/14; H04W 88/04; H04W 72/02; H04W 76/14; H04W 80/02; H04W 92/18

(52) U.S. Cl. CPC H04W 72/14; H04W 88/04; H04W 92/18; H04W 76/14; H04W 80/02; H04W 72/02

(57) ABSTRACT

Aspects of the disclosure relate to wireless communications systems including the use of a joint grant generated in and transmitted by a base station to a user equipment (UE) over a first communication link for establishing a sidelink (SL) with a relay UE. The joint grant provides a first resource assignment for establishing the SL between the UE and relay UE, as well as a second resource assignment that is transmitted to the relay UE for establishing an uplink from the relay UE to the base station.

### PRIORITY CLAIM AND CROSS REFERENCE TO RELATED APPLICATIONS

This application claims priority to and the benefit of U.S. Provisional Application No. 62/991,509 filed in the U.S. Patent and Trademark Office on Mar. 18, 2020, which is incorporated herein by reference as if fully set forth below in its entirety and for all applicable purposes.

### TECHNICAL FIELD

The technology discussed herein relates generally to wireless communication networks and, more particularly, to joint grants or resource assignments used to configure uplink (UL) and sidelink (SL) communications for a user equipment (UE) and a relay UE.

### INTRODUCTION

Wireless communication systems use link diversity such as relaying in varying capacities. Relaying in wireless networks seeks to extend base station coverage, improve transmission reliability, and recover failed links due to, for example, blockage or fading. A relaying node to effect this relaying may be a fixed node or a mobile device (e.g., a user equipment (UE)). Additionally, relaying between mobile devices helps to achieve link diversity through the use of device to device (D2D) technology, which allows UEs to communicate over direct links with one another, which are also referred to herein as sidelinks (SLs), instead of through the cellular network infrastructure (e.g., through a base station).

Under the Third Generation Partnership Project (3GPP) new radio (NR) specifications, D2D may employ higher frequency transmissions in the Frequency Range 2 (FR2) frequency bands, which corresponds to frequency transmissions in the range of 24.25 to 52.6 gigahertz (GHz), or other higher frequency ranges. In the FR2 bands, in particular, the direct links can be impaired or blocked for brief periods, which further increases the desirability of using link diversity such as through the use of relay UEs.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method for wireless communication at a user equipment (UE) in a wireless communication network is disclosed. The method includes receiving a joint grant from a base station over a first communication link. The joint grant includes a first resource assignment portion for assigning resources for transmissions between the UE and a relay user equipment (UE) over a second communication link, and a second resource assignment portion for assigning uplink resources for transmissions between the relay UE and the base station over a third communication link. Furthermore, the method includes establishing the second communication link based on the first resource assignment portion, and sending the second resource assignment portion to the relay UE via the second communication link.

In another example, a user equipment (UE) configured for wireless communication is disclosed. The UE includes a processor, a memory communicatively coupled to the processor, and a transceiver communicatively coupled to the processor. The processor and the memory are configured to receive a joint grant from a base station over a first communication link, where the joint grant comprises a first resource assignment portion for assigning resources for transmissions between the UE and a relay user equipment (UE) over a second communication link, and a second resource assignment portion for assigning uplink resources for transmissions between the relay UE and the base station over a third communication link. The processor and memory are further configured to establish the second communication link based on the first resource assignment portion, and send the second resource assignment portion to the relay UE via the third communication link.

In yet another example, a method for wireless communication at a base station in a wireless communication network is disclosed. The method includes sending a joint grant from the base station to a user equipment (UE) over a first communication link, where the joint grant comprises a first resource assignment portion for assigning resources for transmissions between the UE and a relay user equipment (UE) over a second communication link, and a second resource assignment portion for assigning uplink resources for transmissions between the relay UE and the base station over a third communication link. The method also includes receiving uplink (UL) communication data from the relay UE via the third communication link.

A method for wireless communication at a relay user equipment (UE) in a wireless communication network is disclosed. The method includes receiving, in the relay UE, at least a first portion of a joint grant from a UE over a sidelink communication link, wherein the joint grant is transmitted by a base station to the UE over a first communication link and comprises a sidelink resource assignment portion for assigning resources for transmissions between the UE and the relay UE over the sidelink communication link, and the first portion comprises a resource assignment portion for assigning uplink resources for transmissions between the relay UE and the base station over a second communication link. Additionally, the method includes establishing the second communication link between the relay UE and the base station based on the first portion of the joint grant.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is an illustration of a radio access network according to some aspects.

FIG. 2 is a schematic illustration of an example of a wireless communication system according to some aspects.

FIG. 3 is a schematic illustration of an organization of wireless resources in an air interface utilizing orthogonal frequency divisional multiplexing (OFDM) according to some aspects.

FIG. 4 is a diagram illustrating an exemplary implementation of a wireless communication system according to some aspects.

FIG. 5 is a diagram illustrating another exemplary implementation of wireless communication system according to some aspects.

FIG. 6 is a signaling diagram illustrating exemplary signaling in a communication system for sending a joint grant and establishing SL and UL communication according to some aspects.

FIG. 7 is a diagram illustrating another exemplary implementation of a wireless communication system according to some aspects.

FIG. 8 is a flow chart of an exemplary method for a base station to provide a joint grant to UE and relay UE devices according to some aspects.

FIG. 9 is a block diagram illustrating an example of a hardware implementation for a base station employing a processing system according to some aspects.

FIG. 10 is a flow chart of an exemplary method for a UE to receive and utilize a joint grant according to some aspects.

FIG. 11 is a block diagram illustrating an example of a hardware implementation for a UE employing a processing system according to some aspects.

FIG. 12 is a flow chart of another exemplary method for a relay UE to receive and utilize a joint grant according to some aspects.

FIG. 13 is a block diagram illustrating an example of a hardware implementation for a relay UE employing a processing system according to some aspects.

FIG. 14 is a flow chart of another exemplary method for a relay UE to receive and utilize a joint grant according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Various aspects of the disclosure relate to the use of a joint grant generated in and transmitted by a RAN entity (e.g., gNB or base station) to a user equipment (UE) over a first communication link for establishing a sidelink (SL) with a relay UE. The joint grant is two grants that are combined to jointly provide resource assignments for both a UE and a relay UE for relaying data from the UE to the base station via the relay UE. In an example, the joint grant provides a first resource assignment for establishing the SL between the UE and relay UE, as well as a second resource assignment that is transmitted to the relay UE for establishing an uplink (UL) communication link from the relay UE to the base station.

In some examples, the joint grant may be sent by the base station to the UE on a Uu link, where part of the grant is used by the UE for SL transmit (TX) and another part of the grant is transferred to the relay UE on a PC5 link for the further transmission of relayed data on the UL to the base station via a Uu link. In some further examples, the joint grant may be used for multiple SLs and according multiple relay UEs in a case where there are multiple hops via the multiple SLs. Additionally, the grants may be generated or determined at the media access control (MAC) or layer 2 (L2) level. In yet some further examples, the base station and UE (as well as a relay UE) may be communicating in a mmWave frequency band, such as FR2, FR4, FR4-a, FR4-1, FR5 or other frequency band utilizing spatially directional beams.

While aspects and features are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, aspects and/or uses may come about via integrated chip devices and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described aspects may occur. Implementations may range in spectrum from chip-level or modular components to non-modular, non-chip-level implementations and further to aggregate, distributed, or OEM devices or systems incorporating one or more aspects of the described aspects. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, end-user devices, etc. of varying sizes, shapes and constitution.

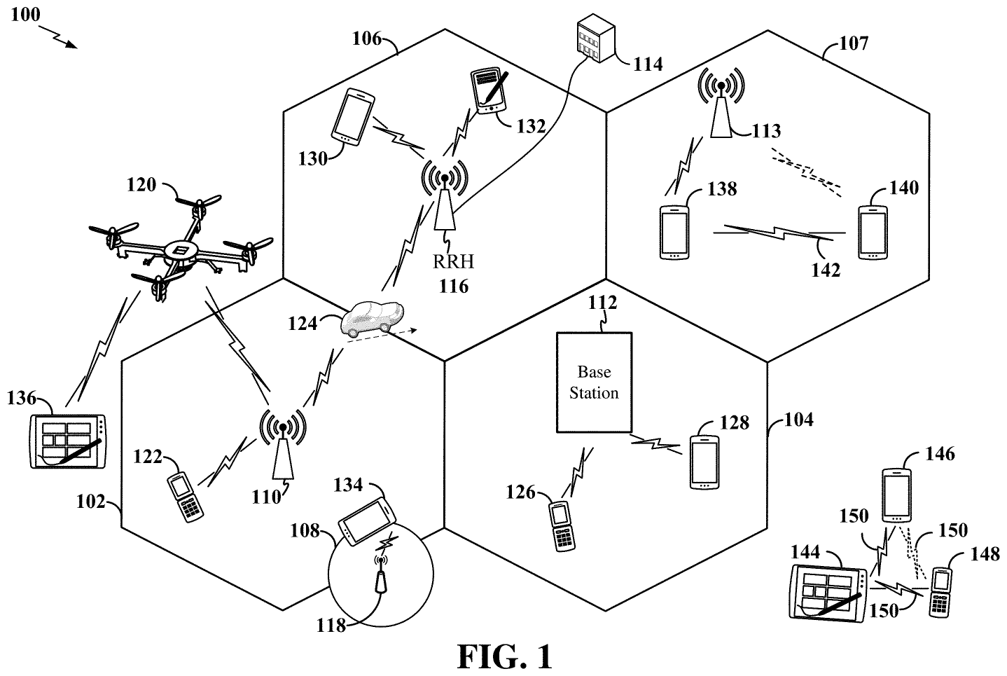

The various concepts presented throughout this disclosure may be implemented across a broad variety of telecommunication systems, network architectures, and communication standards. Referring now to FIG. 1, as an illustrative example without limitation, an illustration of a radio access network 100 is provided. The RAN 100 may implement any suitable wireless communication technology or technologies to provide radio access. As one example, the RAN 100 may operate according to 3rd Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the one or more radio access networks shown in illustration 100 may be divided into a number of cellular regions (cells) that can be uniquely identified by a user equipment (UE) based on an identification broadcasted over a geographical area from one access point or base station. FIG. 1 illustrates macrocells 102, 104, 106, and 107, and a small cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element or entity in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB) a transmission and reception point (TRP), or some other suitable terminology. In some examples, a base station may include two or more TRPs that may be collocated or non-collocated. Each TRP may communicate on the same or different carrier frequency within the same or different frequency band.

In FIG. 1, three base stations 110, 112, and 113 are shown in cells 102, 104, and 107, respectively; and a further base station 114 is shown controlling a remote radio head (RRH) 116 in cell 106. That is, a base station can have an integrated antenna or can be connected to an antenna or RRH by feeder cables or optical fiber. In the illustrated example, the cells 102, 104, 106, 107, and 114 may be referred to as macrocells, as the base stations 110, 112, 113, and 114 support cells having a large size. Further, a base station 118 is shown in the small cell 108 (e.g., a microcell, picocell, femtocell, home base station, home Node B, home eNode B, etc.) which may overlap with one or more macrocells. In this example, the cell 108 may be referred to as a small cell, as the base station 118 supports a cell having a relatively small size. Cell sizing can be done according to system design as well as component constraints. It is noted here that, according to some aspects, the RRH 116 maybe a remote radio transceiver that connects to an operator radio control panel. Additionally, the RRH 116 may contain a base station's RF circuitry plus analog-to-digital/digital-to-analog converters and up/down converters. RRHs also may have operation and management processing capabilities and an interface to connect to the rest of the base station. Additionally, a cell, such as cell 106, may include multiple physical cell sites (e.g., multiple RRHs).

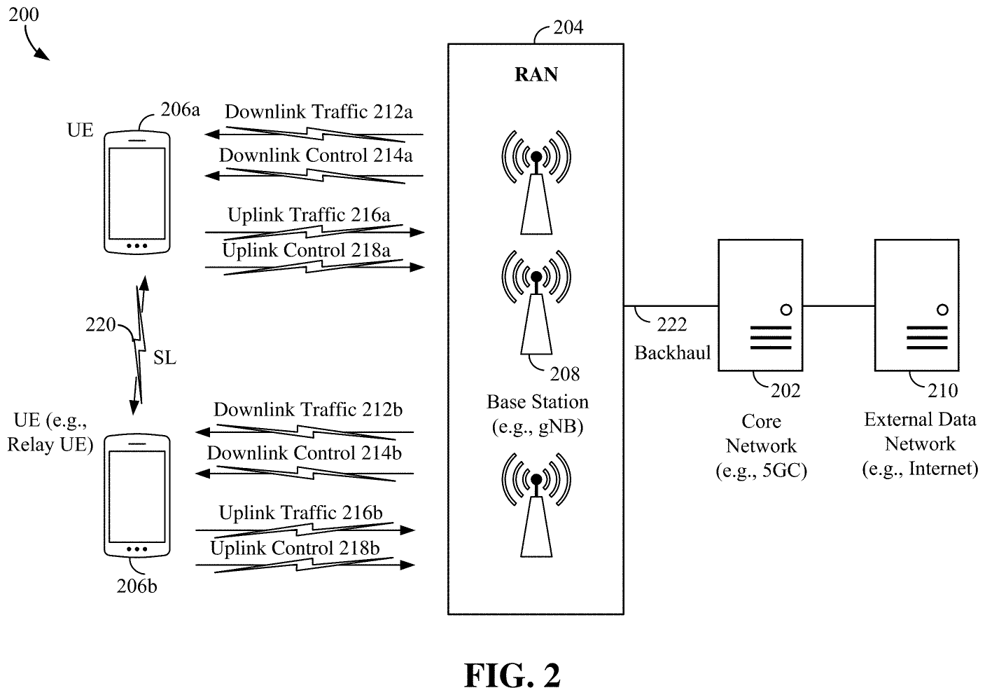

It is to be understood that the radio access network 100 may include any number of wireless base stations and cells. Further, a relay node may be deployed to extend the size or coverage area of a given cell. The base stations 110, 112, 113, 114, and/or 118 provide wireless access points to a core network for any number of mobile apparatuses. In some examples, the base stations 110, 112, 113, 114, and/or 118 may be the same as the base station/scheduling entity 208, which will be described below and illustrated in FIG. 2.

FIG. 1 further includes a mobile base station, which may be implemented with an unmanned aerial vehicle (UAV) 120, such as a quadcopter or drone. That is, in some examples, a cell may not necessarily be stationary, and the geographic area of the cell may move according to the location of a mobile base station such as the UAV 120.

In general, base stations may include a backhaul interface for communication with a backhaul portion (not shown in this figure) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. Further, each base station 110, 112, 113, 114, 118, and 120 may be configured to provide an access point to a core network (See e.g., core network 202, which will be described below in connection with FIG. 2) for all the UEs in the respective cells. For example, UEs 122 and 124 may be in communication with base station 110; UEs 126 and 128 may be in communication with base station 112; UEs 130 and 132 may be in communication with base station 114 by way of RRH 116; UEs 138 and 140 may be in communication with base station 113 (or in communication with the base station 113 via another UE, such as UE 140 in communication with base station 113 via UE 138 and links 142); UE 134 may be in communication with base station 118; and UE 136 may be in communication with mobile base station 120. In another example, a mobile network node (e.g., UAV 120) may be configured to function as a UE. For example, the UAV 120 may operate within cell 102 by communicating with base station 110.

In some examples, access to the air interface may be scheduled, wherein a scheduling entity (e.g., a base station 112) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 126), which may be scheduled entities, may utilize resources allocated by the scheduling entity 112.

Base stations are not the only entities that may function as scheduling entities. That is, in some examples, a UE may function as a scheduling entity, scheduling resources for one or more scheduled entities (e.g., one or more other UEs). And as discussed more below, UEs may communicate directly with other UEs in peer-to-peer (P2P) fashion and/or in relay configuration.

The cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; UEs 138 and 140 may be in communication with base station 113, as well as with each other over a sidelink (SL) 142; and UE 136 may be in communication with mobile base station 120. Here, each base station 110, 112, 113, 114, 118, and 120 may be configured to provide an access point to a core network (not shown) for all the UEs in the respective cells. In another example, a mobile network node (e.g., quadcopter 120) may be configured to function as a UE. For example, the quadcopter 120 may operate within cell 102 by communicating with base station 110.

In some examples, access to the air interface may be scheduled, wherein a scheduling entity (e.g., a base station 112) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 126), which may be scheduled entities, may utilize resources allocated by the scheduling entity 112.

Base stations are not the only entities that may function as scheduling entities. That is, in some examples, a UE may function as a scheduling entity, scheduling resources for one or more scheduled entities (e.g., one or more other UEs). And as discussed more below, UEs may communicate directly with other UEs in peer-to-peer (P2P) fashion and/or in relay configuration.

In a further aspect of the RAN 100, sidelink signals may be used between UEs without necessarily relying on scheduling or control information from a base station. Sidelink communication may be utilized, for example, in a device-to-device (D2D), peer-to-peer (P2P), vehicle-to-vehicle (V2V) network, and/or vehicle-to-everything (V2X). For example, two or more UEs (e.g., UEs 144, 146, and 148) may communicate with each other using peer to peer (P2P) or sidelink signals 150 without relaying that communication through a base station. In some examples, the UEs 144, 146, and 148 may each function as a scheduling entity or transmitting sidelink device and/or a scheduled entity or a receiving sidelink device to schedule resources and communicate sidelink signals 150 therebetween without relying on scheduling or control information from a base station. In other examples, two or more UEs (e.g., UEs 138 and 140) within the coverage area of a base station (e.g., base station 113) may also communicate sidelink signals 142 over a direct link (sidelink) without conveying that communication through the base station 113. In this example, the base station 113 may allocate resources to the UEs 138 and 140 for the sidelink communication. For example, the UEs 138 and 140 may function as scheduling entities or scheduled entities in a P2P network, a device-to-device (D2D), vehicle-to-vehicle (V2V) network, a vehicle-to-everything (V2X), a mesh network, or other suitable network.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

Wireless communication between a RAN and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (e.g., base stations 110, 112, or 113). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (e.g., UE 122).

According to aspects, DL transmissions may include unicast or broadcast transmissions of control information and/or data (e.g., user data traffic or other type of traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier 1-DMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms Duplex refers to a point-to-point communication link where both endpoints can communicate with one another in both directions. Full duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

In a network configured for UL-based mobility, UL reference signals from each UE may be utilized by the network to select a serving cell for each UE. In some examples, the base stations 110, 112, 113, or 114/116 may broadcast unified synchronization signals (e.g., unified Primary Synchronization Signals (PSSs), unified Secondary Synchronization Signals (SSSs) and unified Physical Broadcast Channels (PBCH)). The UEs 122, 124, 126, 128, 130, 132, 138, and 140 may receive the unified synchronization signals, derive the carrier frequency and radio frame timing from the synchronization signals, and in response to deriving timing, transmit an uplink pilot or reference signal. The uplink pilot signal transmitted by a UE (e.g., UE 124) may be concurrently received by two or more cells (e.g., base stations 110 and 114/116) within the RAN 100. Each of the cells may measure a strength of the pilot signal, and the RAN (e.g., one or more of the base stations 110 and 114/116 and/or a central node within the core network) may determine a serving cell for the UE 124. As the UE 124 moves through the RAN 100, the network may continue to monitor the uplink pilot signal transmitted by the UE 124. When the signal strength or quality of the pilot signal measured by a neighboring cell exceeds that of the signal strength or quality measured by the serving cell, the RAN 100 may handover the UE 124 from the serving cell to the neighboring cell, with or without informing the UE 124.

Although the synchronization signal transmitted by the base stations 110, 112, 113, and/or 114/116 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

In order for transmissions over the RAN 100 to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

FIG. 2, as another illustrative example without limitation, illustrates various aspects with reference to a schematic of a wireless communication system 200. The wireless communication system 200 includes three interacting domains: a core network 202, a radio access network (RAN) 204, and one or more user equipment (UE) 206a and/or 206b. By virtue of the wireless communication system 200, the UEs 206a and 206b may be enabled to carry out data communication with an external data network 210, such as (but not limited to) the Internet.

The RAN 204 may implement any suitable wireless communication technology or technologies to provide radio access to the UEs 206a and 206b. As one example, the RAN 204 may operate according to 3^{rd} Generation Partnership Project (3GPP) New Radio (NR) specifications. As another example, the RAN 204 may operate under a hybrid of 5G NR and Evolved Universal Terrestrial Radio Access Network (eUTRAN) standards, often referred to as LTE, such as in non-standalone (NSA) systems including EN-DC systems. The 3GPP also refers to this hybrid RAN as a next-generation RAN, or NG-RAN. Additionally, many other examples may be utilized within the scope of the present disclosure.

As illustrated in FIG. 2, the RAN 204 includes a plurality of base stations 208. In different technologies, standards, or contexts, the base stations 208 may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The RAN 204 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Wireless communication between the RAN 204 and a UE 206a or 206b may be described as utilizing an air interface. Transmissions over the air interface from a base station (e.g., base station 208) to one or more UEs (e.g., UEs 206a or 206b) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 206a or 206b) to a base station (e.g., base station 208) may be referred to as uplink (UL) transmissions. In accordance with further aspects of the present disclosure, the term uplink may refer to a point-to-point transmission originating at a UE (e.g., UE 206a or 206b).

In some examples, access to the air interface may be scheduled, wherein a scheduling entity (e.g., a base station 208) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 206, which may be scheduled entities, may utilize resources allocated by the scheduling entity 208.

As illustrated in FIG. 2, a base station or scheduling entity 208 may broadcast downlink traffic 212a or 212b to one or more scheduled entities 206a or 206b. Broadly, the base station or scheduling entity 208 may be configured as a node or device responsible for scheduling traffic in a wireless communication network, including the downlink traffic 212 and, in some examples, uplink traffic 216a or 216b from one or more scheduled entities 206a or 206b to the scheduling entity 208. The UE or scheduled entity 206a or 206b may be configured as a node or device that also receives downlink control information 214a or 214b, including but not limited to scheduling information (e.g., a grant), synchronization or timing information, or other control information from another entity in the wireless communication network such as the scheduling entity 208. Furthermore, the UEs 206a or 206b may send uplink control information 218a or 218b to the base station 208 including but not limited to scheduling information (e.g., grants), synchronization or timing information, or other control information.

In general, base stations 208 may include a backhaul interface for communication with a backhaul portion 222 of the wireless communication system. The backhaul 222 may provide a link between a base station 208 and the core network 202. Further, in some examples, a backhaul interface may provide interconnection between the respective base stations 208. Various types of backhaul interfaces may be employed, such as a direct physical connection, a virtual network, or the like using any suitable transport network.

The core network 202 may be a part of the wireless communication system 200, and may be independent of the radio access technology used in the RAN 204. In some examples, the core network 202 may be configured according to 5G standards (e.g., 5GC). In other examples, the core network 202 may be configured according to a 4G evolved packet core (EPC), or any other suitable standard or configuration.

In some examples, access to the air interface may be scheduled, wherein a scheduling entity (e.g., a base station 208) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 206a or 206b, which may be scheduled entities, may utilize resources allocated by the base station or scheduling entity 208.

Base stations are not the only entities that may function as a scheduling entity. That is, in some examples, a UE may function as a scheduling entity, scheduling resources for one or more scheduled entities (e.g., one or more other UEs). In other examples, two or more UEs (e.g., UEs 138 and 140 in FIG. 1 or UEs 206a and 206b in FIG. 2) may communicate with each other using sidelink signals such as 142 or 220 without conveying that communication through a base station (e.g., base station 113 or 208) and without necessarily relying on scheduling or control information from a base station. In some examples, the UE 138 or UE 206a is functioning as a scheduling entity or an initiating (e.g., transmitting) sidelink device, and UE 140 or UE 206b may function as a scheduled entity or a receiving sidelink device. For example, the UE 138 may function as a scheduling entity in a device-to-device (D2D) system, peer-to-peer (P2P) system, vehicle-to-vehicle (V2V) network, a vehicle-to-everything (V2X) network, and/or in a mesh network.

For example, in D2D systems, two or more UEs (e.g., UEs 138 and 140 in FIG. 1 or UEs 206a and 206b in FIG. 2) may communicate over a direct link with one other without traversing a base station (e.g., base station 113 or 208). For example, the UEs 138 and 140 or UEs 206a and 206b may communicate using narrow directional beams in the FR2 band (e.g., mmWaves). Here, D2D communication may refer to sidelink communication or relaying communication utilizing sidelink signals. In various aspects of the disclosure, a D2D relay framework may be included within a cellular network to facilitate relaying of communication to/from the base stations 113 or 208 via D2D links (referred to herein as sidelinks 142 or 220). For example, one or more UEs (e.g., UE 138) within the coverage area of the base station 113 or 208 may operate as relaying UEs to extend the coverage of the base station 113 or 208, improve the transmission reliability to one or more UEs (e.g., UE 140 or UE 206b), and/or to allow the base station 113 or 208 to recover from a failed UE link due to, for example, blockage or fading.

In some examples, the sidelinks 142 or 220 may be established as part of a relay node switching process. For example, the UE 138 may have a relay connection to the base station 113 via another UE (e.g., UE 140) and sidelink 142 or UE 206a may have a relay connection to base station 208 via sidelink 220 and UE 206b. The UE 138 or 206a may then select UE 140 or UE 206b as a relay node switch target to switch relaying communication with the base station 113 or 208. Relay node switching may be performed, for example, due to one or more factors, such as movement of the UE, channel variance, a battery status change, and/or a load status change.

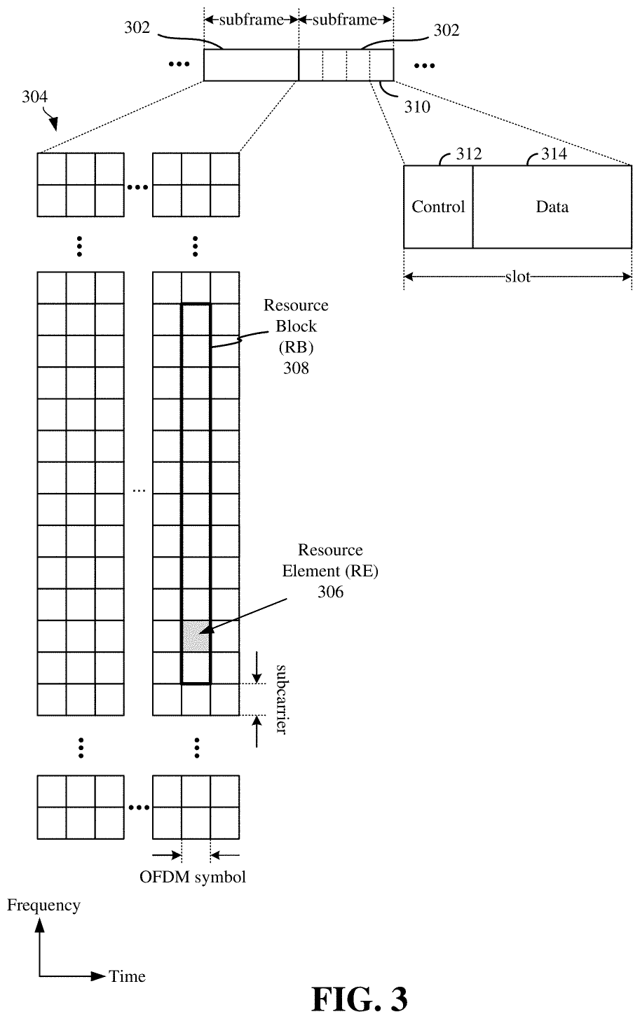

Various aspects of the present disclosure utilize an OFDM waveform, an example of which is schematically illustrated in FIG. 3. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 3, an expanded view of an exemplary DL subframe 302 is illustrated, showing an OFDM resource grid 304. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 304 may be used to schematically represent time-frequency resources for a given antenna port. That is, in a MIMO implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

Scheduling of UEs (e.g., scheduled entities) for downlink or uplink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 402, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

In some examples, the slot 310 may be utilized for broadcast or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); a primary synchronization signal (PSS); and a secondary synchronization signal (SSS). A UE may utilize the PSS and SSS to achieve radio frame, subframe, slot, and symbol synchronization in the time domain, identify the center of the channel (system) bandwidth in the frequency domain, and identify the physical cell identity (PCI) of the cell. The synchronization signals PSS and SSS, and in some examples, the PBCH and a PBCH DMRS, may be transmitted in a synchronization signal block (SSB). The PBCH may further include a master information block (MIB) that includes various system information, along with parameters for decoding a system information block (SIB). The SIB may be, for example, a SystemInformationType 1 (SIB1) that may include various additional system information. Examples of system information transmitted in the MIB may include, but are not limited to, a subcarrier spacing, system frame number, a configuration of a PDCCH control resource set (CORESET) (e.g., PDCCH CORESET0), and a search space for SIB1. Examples of additional system information transmitted in the SIB1 may include, but are not limited to, a random access search space, downlink configuration information, and uplink configuration information. The MIB and SIB1 together provide the minimum system information (SI) for initial access.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a PC5 interface, the control region 312 of the slot 310 may include a physical sidelink control channel (PSCCH) including sidelink control information (SCI) transmitted by an initiating (transmitting) sidelink device (e.g., V2X or other sidelink device) towards a set of one or more other receiving sidelink devices. The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB and/or a sidelink CSI-RS, may be transmitted within the slot 310.

The channels or carriers described above and illustrated in FIGS. 1 and 2 are not necessarily all the channels or carriers that may be utilized between a scheduling entity or base station 208 and scheduled entities or UEs 206a, 206b, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

As discussed above, during certain conditions, direct communication links between base stations and UEs may be impaired or blocked due to temporary conditions, such as signal interference or physical blockages. In particular, transmissions in the FR2 bands may be more susceptible to such conditions. Accordingly, dual connectivity or utilization of sidelink (SL) relay UEs may be used in such conditions to provide link diversity to ameliorate these impaired or blocked conditions for UEs.

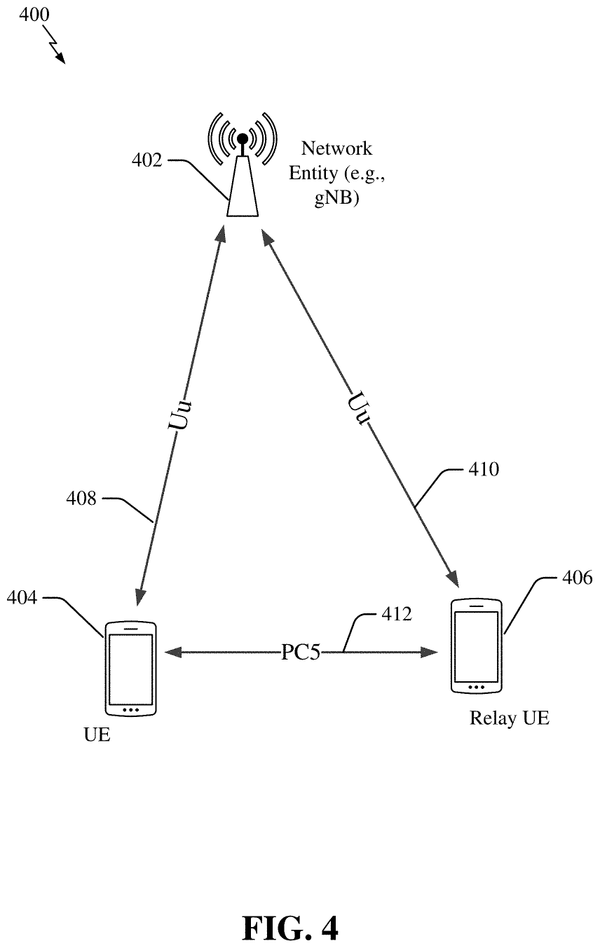

FIG. 4 illustrates a wireless communication system 400 employing link diversity through relaying according to aspects of the present disclosure. The wireless communication system 400 includes a base station 402, such as a gNB, a UE 404, and at least one relay user equipment (UE) 406 that may be used to relay communications from the base station 402 to the UE 404 in the present examples. As illustrated, the base station 402 may be configured to communicate with the UE 404 via a communication link 408 (also referred to herein as a “first communication link”). In the illustrated example, the communication link 408 may be implemented with a 5G NR Uu interface or protocol stack, but the disclosure is not limited to such and this communication link 408 may be implemented using any number of known interfaces capable of effecting communication between a radio access network and a UE device (RAN/UE interfaces), whether in LTE, 5G NR, or future standards. Additionally, the base station 402 is configured to communicate with the relay UE 406 via a further communication link 410 (referred to herein also as a “second communication link”), which may be an LTE Uu interface as illustrated or any other suitable RAN/UE interface or protocol stack.

During relay of communications between the base station 402 and the UE 404 via relay UE 406, a dedicated direct sidelink (SL) communication link or channel 412 (also referred to herein as a “third communication link”) is set up between the relay UE 406 and the UE 404. This direct SL communication link 412 may be implemented with a sidelink interface such as the illustrated LTE PC5 interface, which is defined in 3GPP Release 14, but the disclosure is not limited to such and direct communication link 412 may be implemented using any of a number of suitable sidelink interfaces defined in 5G NR or beyond. The UE 404 directly communicates with relay UE 406 over the direct SL communication link 412, which does not require the base station 402 for implementation of communication between the two UEs 406 and 404 for ultimately effectuating a relay communication link for data transmissions between base station 402 and UE 404.

In a system using SL communication, such as system 400, it is noted that data grants or assignments of resources (referred to also as a “grant” or “resource assignment” herein) for the SL communication link (e.g., 412) may be controlled and configured by the network; namely a network entity such as a gNB or base station (e.g., base station 402) to the UE (e.g., UE 404). This configuration may relate to both DL and UL communications. Typically, the resource assignment is transmitted from the gNB to the UE via a Uu or similar interface (e.g., communication link 408 in the example of FIG. 4), and then is transferred to a sidelink media access control (MAC) layer within the UE device for control and configuration of the sidelink communications between UEs as specified in 3GPP Release 16. Although Release 16 provides for a single SL-grant transmitted on the NR Uu interface, it may be desirable to further provide a joint grant that configures not only the SL communication link (e.g., 412), but the Uu link as well for both the UE (e.g., UE 404) and at least one relay UE (e.g., relay UE 406).

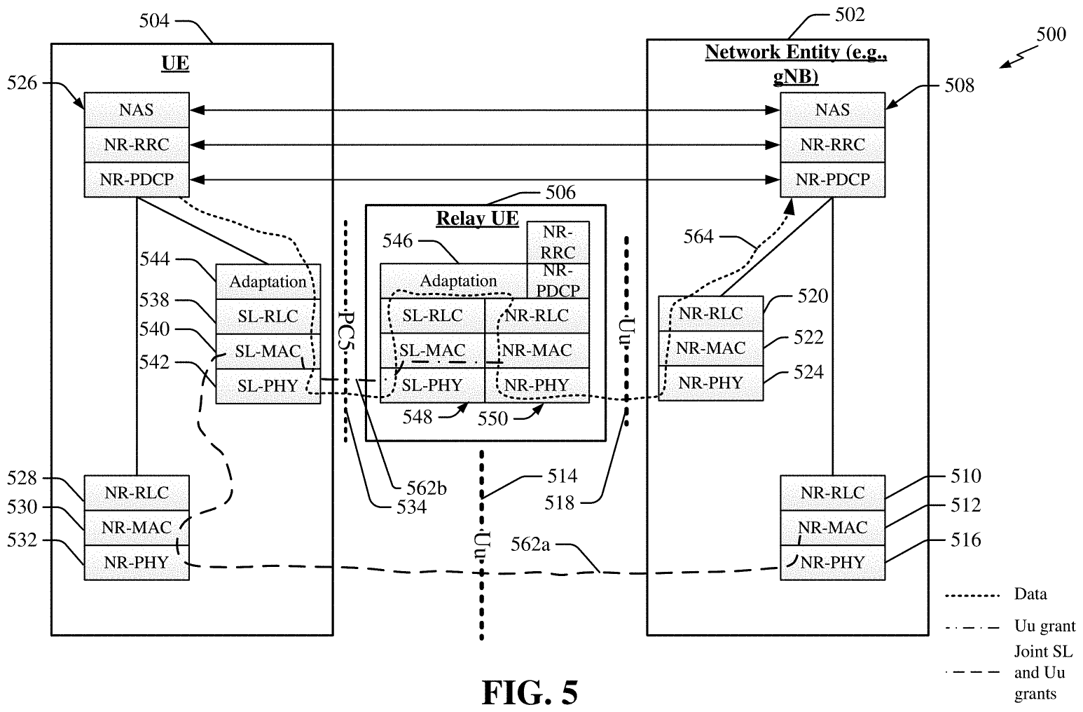

Accordingly, the present disclosure provides a joint grant for resource assignments for a relaying function. In particular, the joint grant provides resource assignments for both the links between the base station or gNB and the UEs and the sidelinks between a UE and at least one relay UE. In a further specific aspect, the joint grant may include grants for the SL transmissions from the UE to the relay UE and for the uplink (UL) transmission of relayed data from the relay UE to the gNB or base station. As will be explained in more detail below with respect to FIG. 5, the joint grant may be first sent from a base station or gNB to a UE over a Uu interface link. A first portion of the joint grant is then used by the UE for SL transmissions with the relay UE, such as via a PC5 communication link or interface. Another second portion of the joint grant is transferred to the relay UE via the PC5 communication link or interface and is used for relaying data via the uplink (UL) between the relay UE and the base station or gNB via another Uu interface or link between the relay UE and the base station or gNB. Furthermore, the joint grant may be configured for scenarios where two or more relay UEs (i.e., the use of two or more SLs) are used for the data link between the UE and the base station or gNB (e.g., multiple relay hops). Moreover, two-stage grants may be utilized where the joint grant is sent in two stages where each portion of the grant is sent at a different time (i.e., a different “stage”). In further aspects, a two-stage grant may be configured as a two-stage downlink control information (DCI) where the SL grant is in the second stage.

FIG. 5 is a diagram illustrating a block diagram of an exemplary wireless communication system 500, which may include or correspond to elements of the communication system of FIG. 4, for example. The wireless communication system 500 includes a network entity such as base station or gNB 502, a UE 504, and a relay UE 506. In an example, the base station 502, UE 504, and relay UE 506 may correspond to base station 402, UE 404, and relay UE 406, respectively. Further, FIG. 5 includes the illustration of grants or resource allocations among various layers of the protocol stacks within each system element as will be discussed in more detail below.

As illustrated, base station or gNB 502 may include higher layer (e.g., layer 3) protocol stack components shown generally at 508, including a Non-Access Stratum (NAS), New Radio-Radio Resource Control (NR-RRC), and New Radio-Packet Data Convergence Protocol (NR-PDCP). The base station or gNB 502 may also include data link layer (i.e., layer 2 or L2) protocol stack components including a New Radio-Radio Link Control (NR-RLC) 510 and a New Radio-Media Access Control (NR-MAC) 512 for communication over a wireless link such as a Uu link shown at 514 for communication with UE 504. Additionally, the protocol stack includes a physical or PHY layer (also known as layer 1 or L1) processing component 516, such as New Radio-Physical (NR-PHY) component.

Furthermore, the base station or gNB 502 may include a second, parallel protocol stack coupled to the network layer component stack 508 and comprised of L2 and L1 components for communication over another Uu communication link 518 with the relay UE 506. This stack is shown by components NR-RLC 520, NR-MAC 522 and NR-PHY 524.

UE 504 also include a layer 3 (i.e., the network layer) protocol stack processing components, such as NAS, NR-RRC, and NR-PDCP as shown generally at 526. Coupled to these components 526 are layer 2 (L2) protocol stack processing components, NR-RLC 528 and NR-MAC 530 for communication over wireless link 514 (e.g., a Uu link) for communication with UE 504. Additionally, the protocol stack includes a layer 1 (L1) processing component NR-PHY 532. Furthermore, UE 504 may also include a second, parallel protocol stack coupled to the network layer component stack 526 and comprise L1 and L2 components for implementing wireless communication over a sidelink (SL) with the relay UE 506, such as via a PC5 communication link 534. This stack is shown by components SL-RLC 538, SL-MAC 540 and SL-PHY 524, where SL indicates that these layers are being utilized for sidelink communication. Above these L1 and L2 components in the stack, UE 504 may also include an adaptation layer in the protocol stack as shown at 544 for adapting packets or frames to be transmitted to the SL communication protocol used for the SL with relay UE 506.

Relay UE 506 includes parallel protocol stacks with a first stack 548 for the SL side including SL-RLC, SL-MAC, and SL-PHY blocks, and a second stack 550 for communication with the base station 502 over interface 518 including NR-RLC, NR-MAC, and NR-PHY blocks. Additionally, the protocol stacks 548, 550 may both include an adaptation layer 546 transcending the stacks as shown for adapting packets or frames received over link 534 for transmission over Uu link 518. It is noted that the protocol stack 550 may include layer 2 processing components NR-RLC and NR-MAC, as well as a layer 1 processing component NR-PHY. Still further, the protocol stacks 548 and 550 (and stack 550 in particular) may have an associated NR Packet Data Convergence Protocol (NR-PDCP) block at a layer above the NR-RLC layer, such as layer 3 (L3) and an NR radio resource control (NR-RRC) block at upper layers served by the NR-PDCP.

In operation, the system 500 may include sending a joint grant from the base station 502 to the UE 504 and the relay UE 506 for controlling and establishing communication for, among other things, the SL communication between UE 504 and relay UE 506 and the UL communication from relay UE 506 to base station 502. According to an example, one grant or resource assignment of the joint grant is a sidelink (e.g., SL PC5 link) grant or resource assignment for the UE 504/to relay 506 SL communication via link 514, and the other grant is a grant or resource assignment for the UL (e.g., Uu link) between the relay 506 and base station 502. Illustrative of this joint grant, FIG. 5 shows with a dashed line the sending of a joint grant 562a from base station 502 to UE 504. In particular, the sending of joint grant 562a is accomplished by layer 2 signaling from NR-MAC 512 to NR-MAC 530 via the layer 1 physical layer (e.g., NR PHY 516 and NR-PHY 532). As the MAC layer in L2 is used for sending the joint grant 562a, this grant could also be referred to as a “MAC joint grant.” Joint grant 562a includes resource assignments for SL link (e.g., SL PC5 link 534) and the NR UL (e.g., the UL portion of Uu link 518 from relay UE 506 to base station 502).

As further shown, the joint grant 562a is passed from NR MAC 530 to SL-MAC 540 within UE 504. The portion of joint grant 562a that is the resource assignment for the SL link 534 (also referred to as a “first resource assignment”) is used to configure and control the SL link 534 when UE 504 transmits data to relay UE 506. Additionally, at least the portion of the joint grant 562a that contains the resource assignment for the UL from relay 506 to base station 502 (also referred to as a “second resource assignment” or “Uu grant” and referenced in FIG. 5 as 562b to denote that this is at least only a portion of joint grant 562a) is sent from the SL-MAC 540 to the SL-MAC in protocol stack 544. This second resource assignment may then further be passed on to the NR-MAC component of protocol stack 544 and is used to configure and control the UL (e.g., Uu interface link 518) when relay UE 506 transmits data to base station 502. An example of the uplink data path from UE 504 to base station 502 via the SL and relay UE 506 is shown by dashed line 564, which traverses the various protocol stack components in each of the wireless devices 502, 504, and 506. Here, the UL data path 564 utilizes resources assigned by the joint grant for (1) SL transmission for the UE 504 to relay UE 506 and (2) UL transmission of the relayed data for relay UE 506 to base station 502.

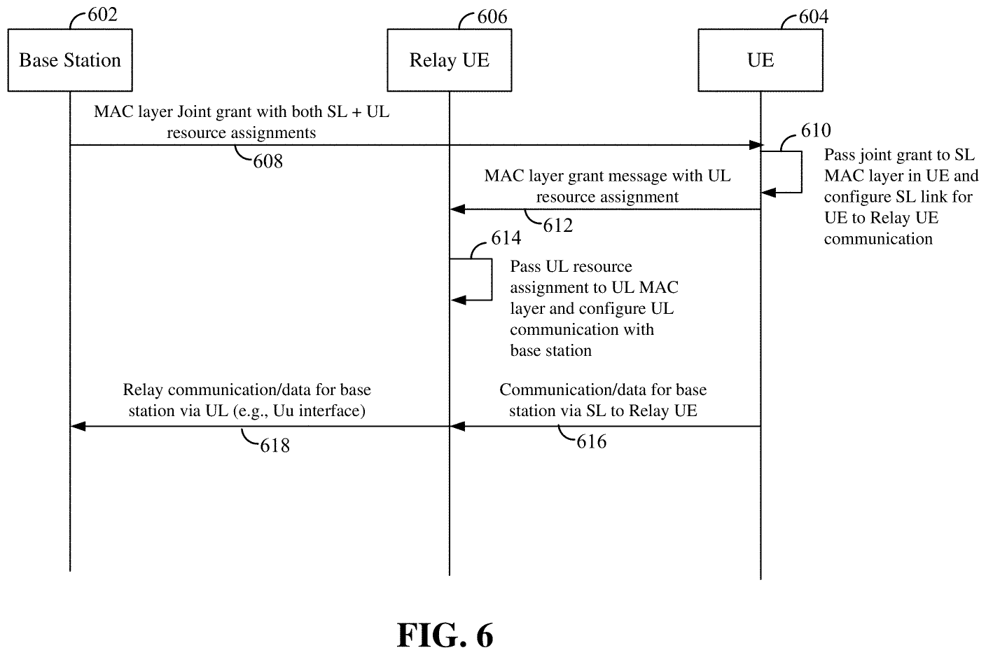

FIG. 6 is a signaling diagram illustrating exemplary signaling in a communication system for sending a joint grant and establishing SL and UL communication, in particular. Similar to the systems 400 and 500 discussed earlier, the system in FIG. 6 includes a base station 602 (e.g., gNB), a UE 604, and a relay UE 606. In an aspect, base station 602 may correspond to base station 402 or 502, UE 604 may correspond to UE 404 or 504, and relay UE 606 may correspond to UE 406 or 506.

The base station 602 sends a joint grant 608 having at least two parts or portions from the MAC layer of the base station 602 over a communication link (e.g., a Uu link) to the UE 604. When received by the UE 604, the joint grant 608 may be passed to an SL-MAC layer in the UE 604 as shown at 610. The joint grant 608 includes a first part of the at least two parts used to assign resources to the UE 604 SL transmissions of data from the UE 604 to the relay UE 606.

A second part of the at least two parts of the grant 608 concerning the UL communication between the relay UE 606 and the base station 602 is transferred by the UE 604 to the relay UE 606 as shown at 612. This transfer may occur over the SL (e.g., PC5 link) between UE 604 and relay UE 606. The second part of the grant is used to assign resources on the UL (e.g., a Uu link) for transmission of the relayed data being relayed from the relay UE 606 to the base station 602. In an aspect, the second part or “UL resource assignment” may be passed from the SL-MAC layer to the UL MAC layer (e.g., NR MAC layer in stack 544 in FIG. 5), which in turn configures the UL for transmission of the relayed data from relay UE 606 and base station 602 as shown at 614. After the joint grant is utilized for configuring the respective resource assignments for the SL and UL links, data may be relayed from the UE 604 to base station 602 via the relay 606 as shown by transmissions 616 and 618.

It is noted that the two parts of the joint grant may be configured as a conditional grant where the two parts are configured to be related with respect to the type of data that they can carry or to be conditional based on shared characteristics/groupings. For example, the granted or assigned UL resource may be used to relay only that data which is transmitted on the SL for resources that have been assigned by the same joint grant. In another example, the granted SL and UL resources may be used only for data belonging to corresponding logical channels (LCHs) on the UL and SL links.

In other aspects, it is noted that transmission of the grant message including the UL resource assignment (e.g., message 612) may include both the second part or portion of the joint grant, as discussed above, but also data that is to be transmitted or relayed by the relay UE 606 to the base station 602. That is, the sidelink transmission sent from the UE 604 to the relay UE 606 on the resources assigned by the grant may include both the second portion of the joint grant and the data being provided to the relay UE 606 for the UL transmission to the base station 602. In a particular aspect, the data for UL transmission via the UL (e.g., Uu interface) is conveyed in message 612 along with the second portion of the grant, rather than via message 616 (e.g., messages 612 and 616 are transmitted concurrently or as one message) Additionally, the configuration the process 614 may also be executed concurrent with a combined message of data and second portion of the grant via message 612 rather than linearly in time as shown in FIG. 6.

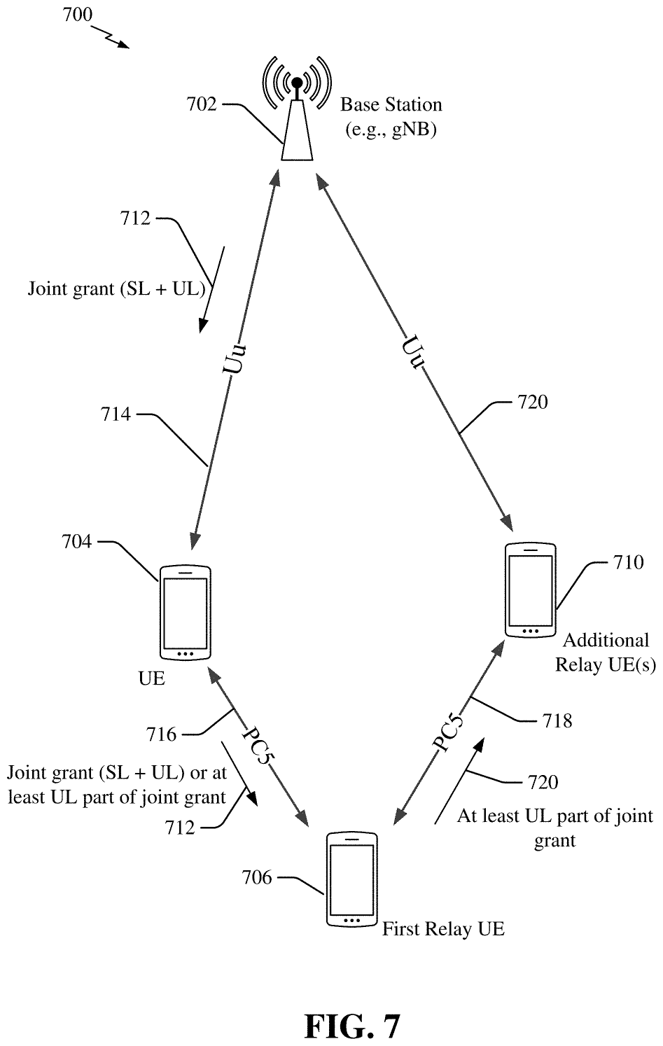

While the examples above relate to a single relay UE, it is further noted that the presently disclosed methods are applicable to systems that utilize a plurality of sidelink relays (and relay UEs) to relay data from a UE to a base station. As an example, FIG. 7 illustrates a wireless communication system 700 with two or more relay UEs. The wireless communication system 700 includes a base station 702, a UE 704, a first relay UE 706, and at least one additional relay UE 710. In this system 700, a joint grant 712 for UL communications includes two parts for SL and UL resource assignments, respectively, and is sent to the UE 704 via a NR link 714, such as a NR Uu link. The UE 704 may be configured to utilize the SL part of the grant 712 in order to configure/control the SL link 716 (e.g., a PC5 interface) between UE 704 and the first relay UE 706. According to an aspect, the UE 704 will pass all parts of the joint grant (i.e., SL+UL) 712 to the first relay UE 706 via the SL link 716. In other aspects, if the SL communication link 718 between the first relay UE 706 and the at least one additional relay UE 710 is configurable without the SL grant part, it is possible that only the UL part of the joint grant need be relayed to the first relay UE 706, relay UE is configured to relay data on the sidelink via the at least one additional relay UE 710 in the sidelink.

When the grant 712 (or a portion thereof in other alternatives) is received by the first relay UE 706, similar to UE 504 in system 500 or UE 604 in FIG. 6, only a part 720 of the joint grant covering the UL link (e.g., Uu interface) need be sent by relay UE 706 to additional relay UE 710 over SL link 718. In turn, additional relay 710 may use the part 720 to then configure resource allocation for link 720 (e.g., the Uu uplink interface). While only one additional relay 710 is illustrated, it is to understood that three or more relay UEs could be utilized and coupled in a concatenated manner to achieve a multiple number of hops.

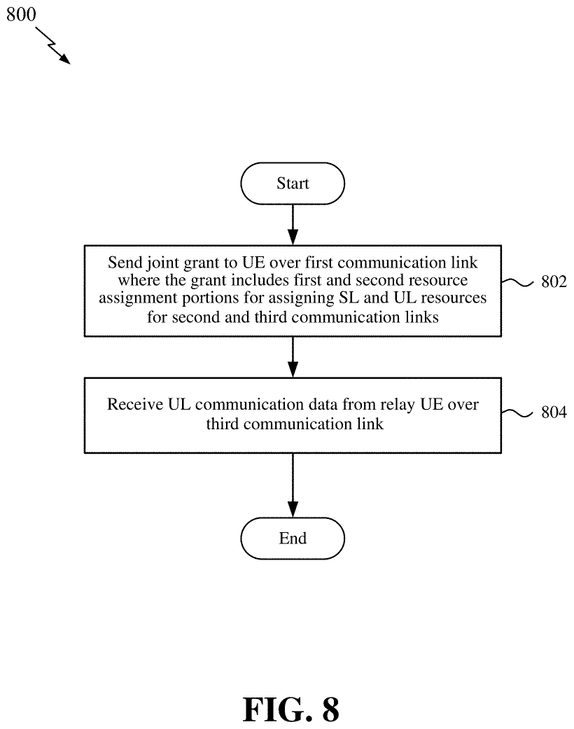

FIG. 8 is a flow diagram of an exemplary method 800 for resource assignment in a wireless communication system. Method 800 includes sending a joint grant from a base station to a user equipment (UE) (e.g., 404, 504, 604, or 704) over a first communication link as shown in block 802. This process may be accomplished by any of base stations 402, 502, 602, or 702, as examples, and the first communication link may be a NR Uu interface, as an example. The process in block 802 further features that the joint grant is configured to include first and second resource assignment portions, where the first resource assignment is configured for assigning resources for transmission between the UE and a relay user equipment (UE) (e.g., 406, 506, 606, 706, or 710) over a second communication link (e.g., PC5 links 412, 534, 716 or 718). Additionally, the process of block 802 may include that the second resource assignment portion is configured for assigning uplink resources for transmissions between the relay UE and the base station over a third communication link, such as a NR uplink (e.g., 410, 518, or 720).

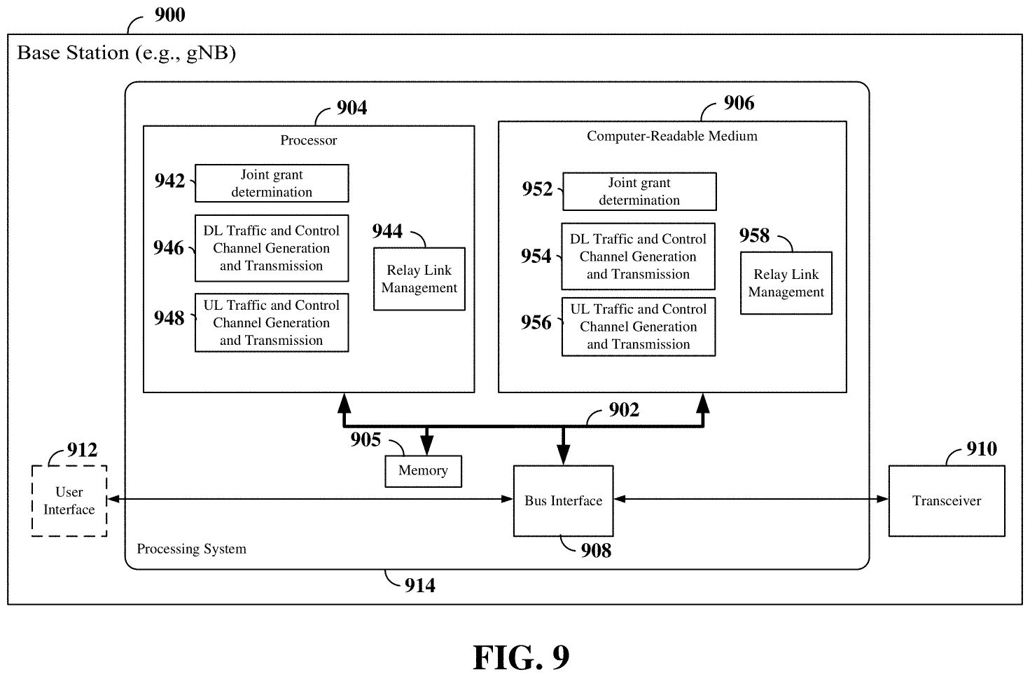

In an example, the sending of the joint grant from the base station to the UE and the configuring of the joint grant to include first and second resource assignment portions may be implemented within a base station, such as a base station 900 to be discussed below in connection with FIG. 9. In an aspect, a joint grant determination circuitry 942 shown in FIG. 9, or equivalents thereof, may provide a means to determine the joint grant, and a transceiver (e.g., 910) in communication therewith may provide a means to send the joint grant. In other examples, the NR-RLC 510, NR-MAC 512, and NR-PHY 516 in network entity 502 shown in FIG. 5 may also, at least in part, provide means for generating and sending the joint grant.

Further, method 800 includes receiving uplink (UL) communication data from the relay UE via the third communication link as shown at block 804, where the UL data is transmitted on the link based on the configuration established using the second portion of the joint grant. This process may include the communications illustrated by 616 and 618 in FIG. 6, as one example.

In an example, reception of the uplink (UL) communication data from the relay UE via the third communication link as shown at block 804, where the UL data is transmitted on the link based on the configuration established using the second portion of the joint grant may be implemented within a base station, such as base station 900. In an aspect, a transceiver, such as transceiver 910 in FIG. 9, or equivalents thereof, may provide means for the reception from the relay UE. In other examples, the NR-RLC 520, NR-MAC 522, and NR-PHY 524 shown in network entity 502 in FIG. 5 may also, at least in part, provide means for receiving the UL communication data via a Uu link (e.g., 518), as one example.

According to further aspects, method 800 may include the first and third communication links being configured according to a first radio access technology (RAT) and the second communication link configured according to a second RAT. According to one example, the first RAT is 5G new radio (NR) technology and the second RAT is a sidelink (SL) technology. Furthermore, as was discussed before, the first and third communication links may comprise Uu interfaces and the second communication link may comprise a sidelink PC5 interface.

In still further aspects, method 800 may include configuring the second resource assignment portion to assigning uplink resources for transmissions between at least one additional relay UE concatenated with the relay UE and configured to communicate with the relay UE via an additional second communication link and to relay communications data from the relay UE to base station via the third communication link. Additionally, the joint grant may be further configured as a two-stage grant where the first resource assignment portion is sent at a first time and the second resource assignment portion is sent at a second time. In an example, if the two-stage grant is sent in a MAC layer packet or frame, a first stage may include the first resource assignment (e.g., the SL resource assignment), which is within the packet or frame at a first time. Some second time later within the MAC frame or packet, the second stage having the second resource assignment (e.g., the UL grant) is placed in the frame or packet.

According to still further aspects, method 800 may include that the first and second resource assignment portions of the joint grant are sent from a media access control (MAC) component of the base station to a corresponding MAC component of the UE. Additionally, it is noted that at least the second resource assignment portion of the joint grant is sent from the MAC component of the base station to a sidelink MAC component of the relay UE via the corresponding MAC component of the UE.

In yet further aspects, method 800 may include configuring the first resource assignment and the second resource assignment of the joint grant to only allow the relaying of data on the second and third communication links that are assigned by the joint grant. Moreover, method 800 may include configuring the first resource assignment and the second resource assignment of the joint grant to only allow the granted resources on the second and third communication links to be used for data belonging to corresponding logical channels (LCHs) of the second and third communication links.

FIG. 9 is a block diagram illustrating an example of a hardware implementation for a base station 900 employing a processing system 914. For example, the base station 900 may correspond to any of the base stations or gNBs previously discussed herein in connection with FIGS. 1, 2, and/or 4-8 or another similar network entity.

The base station 900 may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the base station device 900 may be configured to perform any one or more of the functions described herein. That is, the processor 904, as utilized in the base station 900, may be used to implement any one or more of the processes and procedures described below.

In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further.

A bus interface 908 provides an interface between the bus 902 and a wireless transceiver 910. The wireless transceiver 910 allows for the base station 900 to communicate with various other apparatus over a transmission medium (e.g., air interface). Depending upon the nature of the apparatus, a user interface 912 (e.g., keypad, display, touch screen, speaker, microphone, control knobs, etc.) may also be provided. Of course, such a user interface 912 is optional, and may be omitted in some examples.

The processor 904 is responsible for managing the bus 902 and general processing, including the execution of software stored on the computer-readable medium 906 communicatively coupled to the processor. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 904, causes the processing system 914 to perform the various functions described below for any particular apparatus. The computer-readable medium 906 and the memory 905 may also be used for storing data that is manipulated by the processor 904 when executing software.

The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. In some examples, the computer-readable medium 906 may be part of the memory 905. Those skilled in the art will recognize how best to implement the described functionality presented throughout this disclosure depending on the particular application and the overall design constraints imposed on the overall system.

In some aspects of the disclosure, the processor 904 may include circuitry configured for various functions. For example, the processor 904 may include a relay joint grant determination circuitry 942, which is configured for generating the joint grant discussed herein, including the SL and UL grant portions. Further, processor 904 may include a relay link management circuitry 944 configured to send the joint grant to configure the SL link for a UE and relay UE and the UL link for the UL from the relay UE and the base station. As an example, circuitry 944 may, at least in part, cause the base station to send the joint grant over the Uu link to the UE as is accomplished in process 802 of method 800, as one example. The processor 904 further includes DL traffic and control generation and transmission circuitry 946 for transmitting downlink (DL) data to one or more UEs or relay UEs. Furthermore, the processor 904 includes UL traffic and control generation and transmission circuitry 948 that is configured for control and reception of UL data from one or more UEs or relay UEs. As an example, circuitry 948 may control or affect control of the joint grant for allocating resources on the Uu UL (e.g., 410 or 518).

The computer-readable medium 906 includes joint grant determination software/instructions 952 and relay link management software/information 958 to assist the joint grant determination circuitry 942 and relay management link circuitry 944 in performing their respective functions as previously described. Similarly, the computer readable medium 906 includes DL traffic and control channel generation and transmission software/information 954 to assist the DL traffic and control channel generation and transmission circuitry 946 perform its function as previously described. Additionally, the computer readable medium 906 includes UL traffic and control channel generation and transmission software/information 956 to assist the UL traffic and control channel generation and transmission circuitry 948 perform its function as previously described.

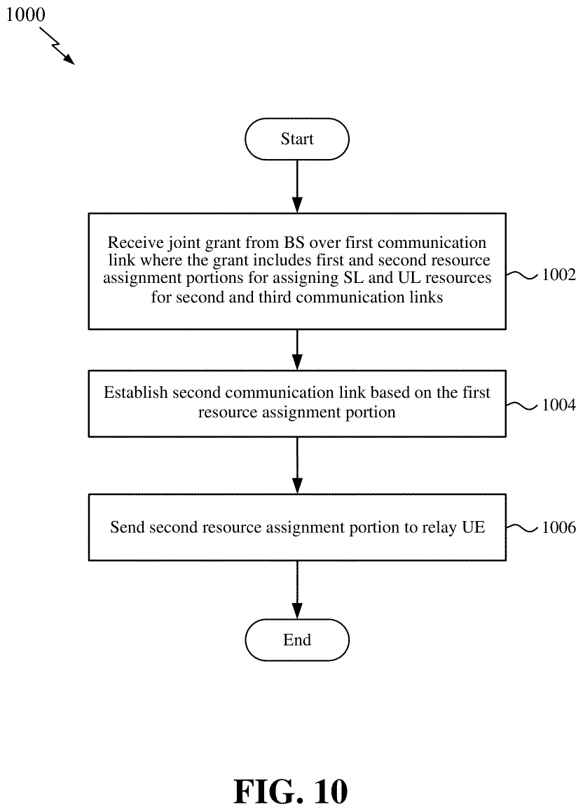

FIG. 10 illustrates a flow diagram of an exemplary method 1000 for receiving a joint grant in a UE from a base station or gNB according to some aspects. Method 1000 includes first receiving a joint grant from a base station (BS) over a first communication link as shown in block 1002. The joint grant includes first and second resource assignment portions for assigning sidelink (SL) and (UL) resources for second and third communication links (e.g., SL link between the UE and relay UE and the UL between the relay UE and the BS). In particular, the first resource assignment portion is configured for assigning resources for transmissions between the UE and a relay user equipment (UE) over a second communication link, and the second resource assignment portion is configured for assigning uplink resources for transmissions between the relay UE and the base station over a third communication link.

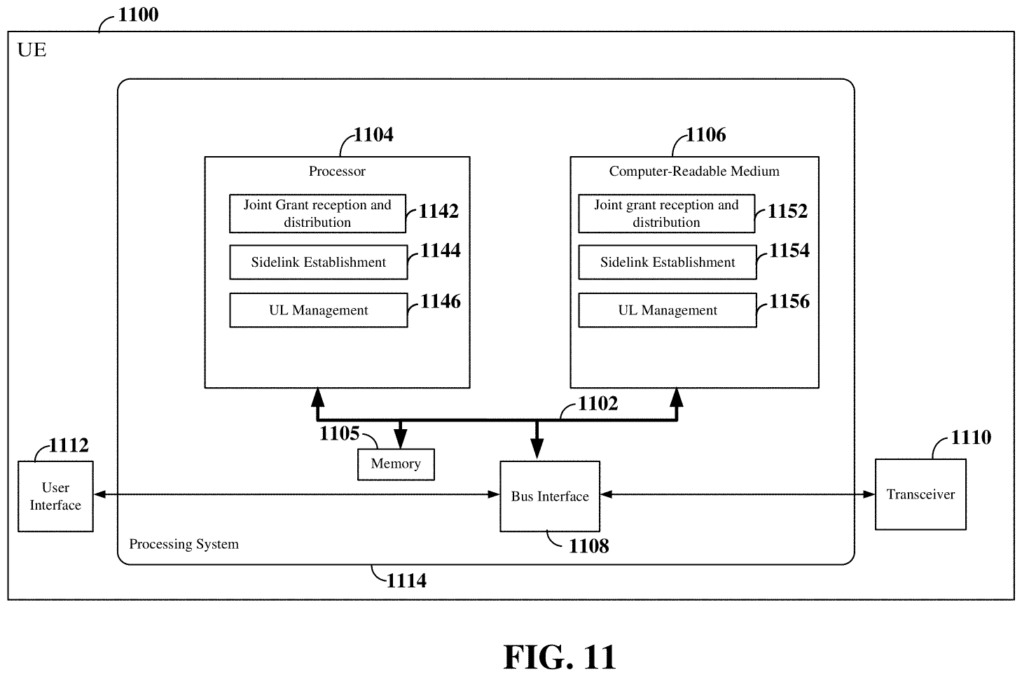

In an example, reception of the joint grant from the base station within the UE and the decoding/processing thereof may be implemented within a UE such as a UE 1100 to be discussed below in connection with FIG. 11. In an aspect, a joint grant reception circuitry 1142 shown in FIG. 11, or equivalents thereof, may provide a means to receive the joint grant, along with a transceiver (e.g., 1110) in communication therewith. In other examples, the NR-PHY 532, NR-MAC 530, and NR-RLC 528 in UE 504 shown in FIG. 5 may also, at least in part, provide means for receiving the joint grant from the base station.

Method 1000 further includes establishing and/or configuring, within the UE, the second communication link based on the first resource assignment portion as shown in block 1004. In an example, establishing and/or configuring, within the UE, the second communication link based on the first resource assignment portion may be implemented within a UE such as a UE 1100 to be discussed below in connection with FIG. 11. In an aspect, a sidelink establishment circuitry 1144 shown in FIG. 11, or equivalents thereof, may provide a means to establish the second communication link (i.e., SL), and may further include a transceiver (e.g., 1110) in communication therewith. In other examples, establishment of the second communication link (e.g., SL PC5 interface 412, 534, 616, 716 and/or 718) may be established with a means for establishing the second communication link including an SL-MAC component (e.g., 540 in FIG. 5) and may also include an SL-PHY component (e.g., 542 in FIG. 5)

Furthermore, method 1000 includes sending the second resource assignment portion to the relay UE via the second communication link as shown at block 1006. The relay UE, in turn, may utilize the second resource assignment to establish and/or configure the UL (e.g., Uu interface link 410 or 518) for UL communication between the relay UE and the base station.

In an example, sending the second resource assignment portion from the UE to the relay UE via the second communication link may be implemented within a UE such as a UE 1100 to be discussed below in connection with FIG. 11. In an aspect, the sidelink establishment circuitry 1144 shown in FIG. 11, or equivalents thereof, may provide a means to send the second resource assignment, along with the transceiver (e.g., 1110) in communication therewith. In other examples, the NR-PHY 532, NR-MAC 530, and NR-RLC 528 in UE 504 shown in FIG. 5 may also, at least in part, provide means for sending the second resource assignment to the relay UE (e.g., 506) via a PC5 link (e.g., 534), for example.

Method 1000 may also include the first and second resource assignment portions of the joint grant being received by a media access control (MAC) component of the UE, such as NR-MAC 530 in FIG. 5 as one example. Furthermore, method 1000 may include distributing or transferring at least the second resource assignment portion of the joint grant received in the MAC component of the UE to a sidelink MAC component of the relay UE via the corresponding sidelink MAC component in the UE. As an example, this process may constitute the transfer of the second resource assignment portion (UL grant) from NR-MAC 530 to SL-MAC 540, which in turn transfers or distributes the second resource assignment portion to the SL-MAC in protocol stack 544 as may be seen in FIG. 5.

FIG. 11 is a conceptual diagram illustrating an example of a hardware implementation for an exemplary UE 1100 employing a processing system 1114. For example, the UE 1100 may be a UE as illustrated in any one or more of the various examples herein such as was illustrated in any of FIGS. 1, 2, and/or 4-8 or another similar UE or scheduled entity operable in the wireless communication system.

The processing system 1114 may be substantially the same as the processing system 914 illustrated in FIG. 9, including a bus interface 1108, a bus 1102, memory 1105, a processor 1104, and a computer-readable medium 1106. Furthermore, the UE 1100 may include a user interface 1112 and a transceiver 1110 substantially similar to those described above in FIG. 9. In accordance with various aspects of the disclosure, an element, or any portion of an element, or any combination of elements may be implemented with the processing system 1114 that includes one or more processors 1104. That is, the processor 1104, as utilized in a UE 1100, may be used to implement any one or more of the processes described below.

In some aspects of the disclosure, the processor 1104 may include circuitry configured for various functions. For example, the processor 1104 may include joint grant reception and distribution circuitry 1142 configured to receive the joint grant from a base station via a Uu interface or other NR interface or beyond. The joint grant reception and distribution circuitry 1142 may further be configured to distribute at least a portion of the joint grant to other components such as a sideline establishment circuit 1144. In an example, circuitry 1142 may include NR-MAC 530, and SL-MAC 540, as well as other communicative couplings in various protocol stacks in the UE. In some examples, the sidelink establishment circuitry 1144 may be configured to establish, configure, and effectuate communication between the UE 110 and one or more relay UEs via a SL interface such as a PC5 interface (e.g., 534 in FIG. 5). The processor 1104 may further include a UL management circuitry 1146, which is configured to manage UL transmissions from the UE 1100 to a base station via one or more relay UEs.

The computer-readable medium 1106 includes joint grant determination software/instructions 1152 and sidelink establishment software/instructions 1154 that receive the distributed joint grant (or a portion thereof) to perform their respective functions as previously described. Similarly, the computer readable medium 1106 also includes UL management software/instructions 1156 to assist the UL management circuitry 1146 in performing its function as previously described.

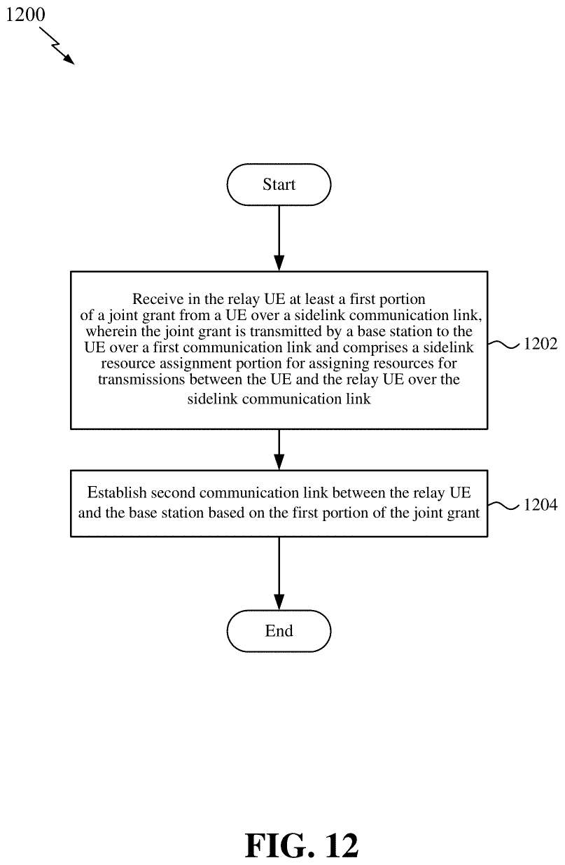

FIG. 12 is a flow chart of another exemplary method 1200 for a relay UE to receive and utilize at least a portion of a joint grant according to some aspects. Method 1200 includes first receiving in the relay UE at least a first portion of a joint grant from a UE over a sidelink communication link, wherein the joint grant is transmitted by a base station to the UE over a first communication link and comprises a sidelink resource assignment portion for assigning resources for transmissions between the UE and the relay UE over the sidelink communication link as illustrated in block 1202. The first portion comprises a resource assignment portion, which was previously referred to as a “second resource assignment portion” for methods 800 and 1000. The recourse assignment portion is configured for assigning uplink resources for transmissions between the relay UE and the base station over a second communication link (e.g., the UL Uu link between a relay UE and base station or gNB). Method 1200 further includes next establishing the second communication link between the relay UE and the base station based on the first portion of the joint grant as shown at block 1204.

According to other aspects, method 1200 may also include relaying uplink (UL) communication data received from the UE via the sidelink communication link to the base station via the second communication link. Moreover, method 1200 may include configuring the resource assignment portion to assign uplink resources for transmissions between at least one additional relay UE concatenated with the relay UE and configured to communicate with the relay UE via an additional sidelink communication link and to relay communications data from the UE to the base station via the second communication link.

According to yet another aspect, method 1200 may include that the resource assignment portion of the joint grant is received by a media access control (MAC) component of the relay UE from a MAC component in the UE.

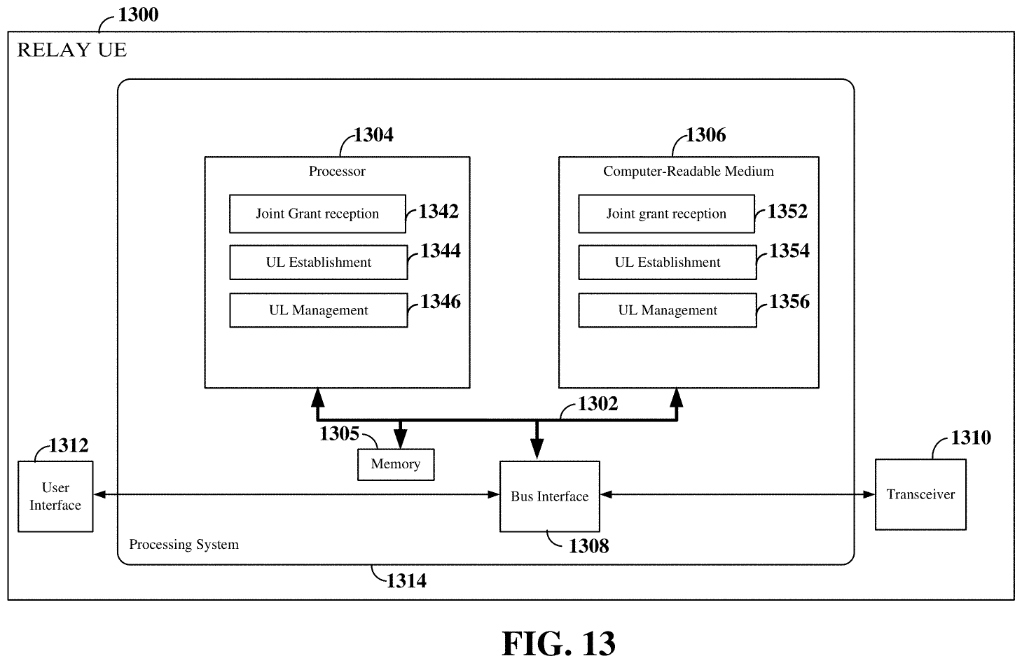

FIG. 13 is a block diagram illustrating an example of a hardware implementation for a relay UE 1300 employing a processing system according to some aspects. In particular, FIG. 13 is a conceptual diagram illustrating an example of a hardware implementation for an exemplary relay UE 1300 employing a processing system 1314. For example, the relay UE 1300 may be a relay UE as illustrated in any one or more of the various examples herein in connection with FIGS. 1, 2, and/or 4-8 or another similar UE or scheduled entity that may be used for relaying with the wireless communication system.

The processing system 1314 may include a bus interface 1308, a bus 1302, memory 1305, a processor 1304, and a computer-readable medium 1306. Furthermore, the relay UE 1300 may include a user interface 1312 and a transceiver 1310 substantially similar to those described above in FIG. 9 or 11. In accordance with various aspects of the disclosure, an element, or any portion of an element, or any combination of elements may be implemented with the processing system 1314 that includes one or more processors 1304. That is, the processor 1304, as utilized in a relay UE 1300, may be used to implement any one or more of the processes described below.

In some aspects of the disclosure, the processor 1304 may include circuitry configured for various functions. For example, the processor 1304 may include joint grant reception circuitry 1342 configured to receive the portion of the joint grant from a UE via a sidelink interface (e.g., PC5). The joint grant reception circuitry 1142 may further be configured to coordinate with UL establishment circuit 1344 to establish a Uu UL link between the relay UE and a base station. In an example, circuitry 1342 may include at least the NR-MAC component in protocol stack 544 as one example. The processor 1304 may further include a UL management circuitry 1346, which is configured to manage UL transmissions from the relay UE 1300 to a base station (or one or more relay UEs in other examples).

The computer-readable medium 1306 includes joint grant reception software/instructions 1352 and UL establishment software/instructions 1354 that receive the joint grant (or a portion thereof) to perform their respective functions as previously described. Similarly, the computer readable medium 1306 also includes UL management software/instructions 1356 to assist the UL management circuitry 1346 in performing its function as previously described.

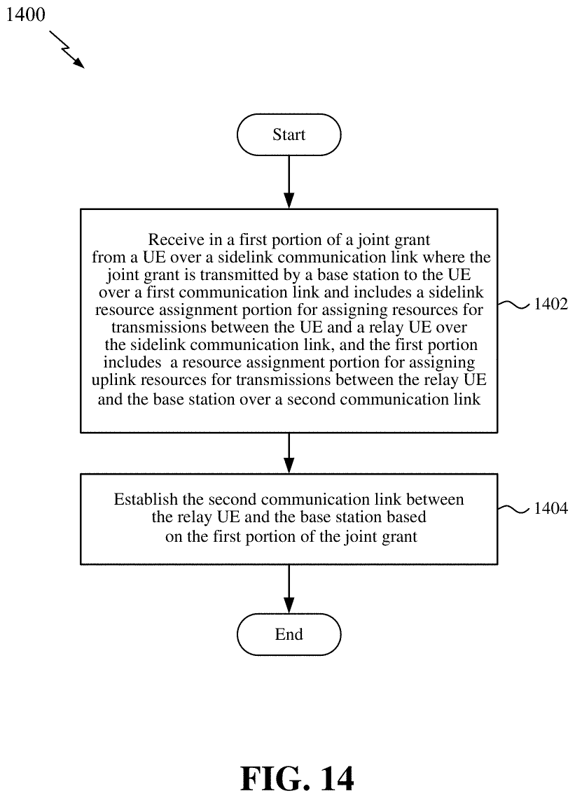

FIG. 14 illustrates a flow diagram of an exemplary method 1400 for wireless communication at a relay user equipment (UE) in a wireless communication network wherein the relay UE receives a joint grant in a relay UE from a base station and other UE according to some aspects. Some or all illustrated features may be omitted in a particular implementation within the scope of the present disclosure, and some illustrated features may not be required for implementation of all aspects. In some examples, the method 1400 may be performed by the relay UE 1300, as described above and illustrated in FIG. 13, by any other UEs illustrated herein including 206b, 406, 506, 606, 706, or 710, by a processor or processing system, or by any suitable means for carrying out the described functions.

At block 1402, method 1400 includes receiving, in the relay UE, at least a first portion of a joint grant from a UE over a sidelink communication link, wherein the joint grant is transmitted by a base station to the UE over a first communication link and includes a sidelink resource assignment portion for assigning resources for transmissions between the UE and the relay UE over the sidelink communication link. Further, the first portion includes a resource assignment portion for assigning uplink resources for transmissions between the relay UE and the base station over a second communication link.

In an example, the reception of the joint grant over the sidelink communication link is performed in the relay UE. As an example, the reception of the joint grant may include the joint grant reception circuitry 1342 shown and described above in connection with FIG. 13 may provide a means to determine and/or decode/process the joint grant information. This means may also include transceiver 1310 in communication with the joint grant reception circuitry 1342. In yet further aspects, the joint grant reception circuitry 1342 may provide means for determining/decoding the resource assignment portion for assigning uplink resources for transmissions between the relay UE and the base station over the second communication link. In still other examples, means for the reception and/or decoding/processing of the joint grant over the sidelink communication link in the relay UE may be implemented by the first protocol stack 548, as illustrated in FIG. 5, and may also include the adaptation block 546.

At block 1404, method 1400 includes establishing the second communication link between the relay UE and the base station based on the first portion of the joint grant. As an example, the UL establishment circuitry 1344 shown and described above in connection with FIG. 13 may provide a means for establishing the second communication link between the relay UE and the base station based on the first portion of the joint grant via an UL such as Uu link 518 in FIG. 5. This means may also include transceiver 1310 in communication with the UL establishment circuitry 1344. In yet further aspects, the UL management circuitry 1346 may provide means for continued implementation of the second communication link between the relay UE and the base station over the Uu link 518, as one example. In still other examples, means for the UL for establishing the second communication link may be implemented by the second protocol stack 550, as illustrated in FIG. 5, and may also include the adaptation block 546, as well as the NR-RRC and NR-PDCP in the second stack 550.

In further aspects, method 1400 may include relaying uplink (UL) communication data received from the UE via the sidelink communication link to the base station via the second communication link. Moreover, method 1400 may include configuring the resource assignment portion to assign uplink resources for transmissions between at least one additional relay UE concatenated with the relay UE and configured to communicate with the relay UE via an additional sidelink communication link and to relay communications data from the UE to the base station via the second communication link.

In further aspects, method 1400 may include the joint grant being further configured as a two-stage grant wherein the sidelink resource assignment portion is received at a first time and the resource assignment portion is received at a second time. Additionally, the joint grant may be received by a media access control (MAC) component of the relay UE, such as SL-MAC in first protocol stack 548, as one example. In yet another aspect, method 1400 may include allowing only the granted resources on the second communication link to be used for data belonging to corresponding logical channels (LCHs) of the second communication link. This process of limiting transmission resource to LCHs of the second communication link may be implemented through the use of second protocol stack 550, as illustrated in FIG. 5, as well as the NR-RRC and NR-PDCP in the second stack 550 as one example.

The following provides an overview of aspects of the present disclosure:

Aspect 1: A method for wireless communication at a user equipment (UE) in a wireless communication network, the method comprising: receiving a joint grant from a base station over a first communication link, the joint grant comprising: a first resource assignment portion for assigning resources for transmissions between the UE and a relay user equipment (UE) over a second communication link; and a second resource assignment portion for assigning uplink resources for transmissions between the relay UE and the base station over a third communication link; establishing the second communication link based on the first resource assignment portion; and sending the second resource assignment portion to the relay UE via the second communication link.

Aspect 2: The method of aspect 1, further comprising: transmitting uplink (UL) communication data from the base station via the relay UE using the second and third communication links.

Aspect 3: The method of aspect 2, further comprising: the first and third communication links configured according to a first radio access technology (RAT) and the second communication link configured according to a second RAT.

Aspect 4: The method of aspect 3, wherein the first RAT is 5G new radio (NR) technology and the second RAT is a sidelink (SL) technology.

Aspect 5: The method of any of aspects 1 through 4, wherein the first and third communication links comprise Uu interfaces and the second communication link comprises a sidelink PC5 interface.

Aspect 6: The method of any of aspects 1 through 5, further comprising: configuring the second resource assignment portion to assign uplink resources for transmissions between at least one additional relay UE concatenated with the relay UE and configured to communicate with the relay UE via an additional second communication link and to relay communications data from the relay UE to base station via the third communication link.

Aspect 7: The method of any of aspects 1 through 6, wherein the joint grant is further configured as a two-stage grant wherein the first resource assignment portion is received at a first time and the second resource assignment portion is received at a second time.

Aspect 8: The method of any of aspects 1 through 7, wherein the first and second resource assignment portions of the joint grant are received by a media access control (MAC) component of the UE.

Aspect 9: The method of aspect 8, further comprising: transferring at least the second resource assignment portion of the joint grant received in the MAC component of the UE to a sidelink MAC component of the relay UE via the corresponding sidelink MAC component in the UE.

Aspect 10: The method of any of aspects 1 through 9, further comprising: relaying only data on the second communication link to the relay UE that is assigned by the joint grant for transmission of the data by the relay UE to the base station over the third communication link.

Aspect 11: The method of any of aspects 1 through 10, further comprising: allowing only the granted resources on the second communication link to be used for data belonging to corresponding logical channels (LCHs) of the second communication link.

Aspect 12: A method for wireless communication at a base station in a wireless communication network, the method comprising: sending a joint grant from the base station to a user equipment (UE) over a first communication link, the joint grant comprising: a first resource assignment portion for assigning resources for transmissions between the UE and a relay user equipment (UE) over a second communication link; and a second resource assignment portion for assigning uplink resources for transmissions between the relay UE and the base station over a third communication link; and receiving uplink (UL) communication data from the relay UE via the third communication link.

Aspect 13: The method of aspect 12, wherein the UL communication data is uplink data from the UE relayed by the relay UE.

Aspect 14: The method of aspect 13, further comprising: the first and third communication links configured according to a first radio access technology (RAT) and the second communication link configured according to a second RAT.

Aspect 15: The method of aspect 14, wherein the first RAT is 5G new radio (NR) technology and second RAT is a sidelink (SL) technology.

Aspect 16: The method of any one of aspects 12 through 15, wherein the first and third communication links comprise Uu interfaces and the second communication link comprises a sidelink PC5 interface.

Aspect 17: The method of any one of aspects 12 through 16, further comprising: configuring the second resource assignment portion to assign uplink resources for transmissions between at least one additional relay UE concatenated with the relay UE and configured to communicate with the relay UE via an additional second communication link and to relay communications data from the relay UE to base station via the third communication link.

Aspect 18: The method of any one of aspects 12 through 17, wherein the joint grant is further configured as a two-stage grant wherein the first resource assignment portion is sent at a first time and the second resource assignment portion is sent at a second time.

Aspect 19: The method of any one of aspects 12 through 18, wherein the first and second resource assignment portions of the joint grant are sent from a media access control (MAC) component of the base station to a corresponding MAC component of the UE.

Aspect 20: The method of any one of aspects 12 through 19, wherein at least the second resource assignment portion of the joint grant is sent from the MAC component of the base station to a sidelink MAC component of the relay UE via the corresponding MAC component of the UE.

Aspect 21: The method of any one of aspects 12 through 20, further comprising: configuring the first resource assignment and the second resource assignment of the joint grant to only allow the relaying of data on the second and third communication links that are assigned by the joint grant.

Aspect 22: The method of any one of aspects 12 through 21, further comprising: configuring the first resource assignment and the second resource assignment of the joint grant to only allow the granted resources on the second and third communication links to be used for data belonging to corresponding logical channels (LCHs) of the second and third communication links.

Aspect 23: A method for wireless communication at a relay user equipment (UE) in a wireless communication network, the method comprising: receiving in the relay UE at least a first portion of a joint grant from a UE over a sidelink communication link, wherein the joint grant is transmitted by a base station to the UE over a first communication link and comprises a sidelink resource assignment portion for assigning resources for transmissions between the UE and the relay UE over the sidelink communication link, and the first portion comprises a resource assignment portion for assigning uplink resources for transmissions between the relay UE and the base station over a second communication link; and establishing the second communication link between the relay UE and the base station based on the first portion of the joint grant.

Aspect 24: The method of aspect 23 further comprising: relaying uplink (UL) communication data received from the UE via the sidelink communication link to the base station via the second communication link.

Aspect 25: The method of aspect 23 or 24, wherein the first and second communication links comprise Uu interfaces and the sidelink communication link comprises a sidelink PC5 interface.

Aspect 26: The method of any one of aspects 23 through 25, further comprising: configuring the resource assignment portion to assign uplink resources for transmissions between at least one additional relay UE concatenated with the relay UE and configured to communicate with the relay UE via an additional sidelink communication link and to relay communications data from the UE to the base station via the second communication link.

Aspect 27: The method of any one of aspects 23 through 26, wherein the joint grant is further configured as a two-stage grant wherein the sidelink resource assignment portion is received at a first time and the resource assignment portion is received at a second time.

Aspect 28: The method of any one of aspects 23 through 27, wherein the resource assignment portion of the joint grant is received by a media access control (MAC) component of the relay UE.

Aspect 29: The method of aspects 23 through 28, further comprising: allowing only the granted resources on the second communication link to be used for data belonging to corresponding logical channels (LCHs) of the second communication link.

Aspect 30: A UE configured for wireless communication comprising a processor, and a memory coupled to the processor, the processor and memory configured to perform a method of any one of aspects 1 through 12.

Aspect 31: A base station configured for wireless communication comprising a processor, and a memory coupled to the processor, the processor and memory configured to perform a method of any one of aspects 13 through 22.

Aspect 32: A relay UE configured for wireless communication comprising a processor, and a memory coupled to the processor, the processor and memory configured to perform a method of any one of aspects 23 through 29.

Aspect 33: An apparatus configured for wireless communication comprising at least one means for performing a method of any one of aspects 1 through 12, 13 through 22, or aspects 23 through 29.

Aspect 34: A non-transitory computer-readable medium storing computer-executable code, comprising code for causing an apparatus to perform a method of any one of aspects 1 through 12, 13 through 22, or aspects 23 through 29.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIG. 1-7, 9, 11, or 13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication at a user equipment (UE) in a wireless communication network, the method comprising:
receiving a joint grant from a base station over a first communication link, the joint grant comprising:
a first resource assignment portion for assigning resources for transmissions between the UE and a relay user equipment (UE) over a second communication link; and
a second resource assignment portion for assigning uplink resources for transmissions between the relay UE and the base station over a third communication link;
establishing the second communication link based on the first resource assignment portion; and
sending the second resource assignment portion to the relay UE via the second communication link.

2. The method of claim 1, further comprising:
transmitting uplink (UL) communication data from the base station via the relay UE using the second and third communication links.

3. The method of claim 2, further comprising:
the first and third communication links configured according to a first radio access technology (RAT) and the second communication link configured according to a second RAT.

4. The method of claim 3, wherein the first RAT is 5G new radio (NR) technology and the second RAT is a sidelink (SL) technology.

5. The method of claim 1, wherein the first and third communication links comprise Uu interfaces and the second communication link comprises a sidelink PC5 interface.

6. The method of claim 1, further comprising:
configuring the second resource assignment portion to assign uplink resources for transmissions between at least one additional relay UE concatenated with the relay UE and configured to communicate with the relay UE via an additional second communication link and to relay communications data from the relay UE to base station via the third communication link.

7. The method of claim 1, wherein the joint grant is further configured as a two-stage grant wherein the first resource assignment portion is received at a first time and the second resource assignment portion is received at a second time.

8. The method of claim 1, wherein the first and second resource assignment portions of the joint grant are received by a media access control (MAC) component of the UE.

9. The method of claim 8, further comprising:
transferring at least the second resource assignment portion of the joint grant received in the MAC component of the UE to a sidelink MAC component of the relay UE via the corresponding sidelink MAC component in the UE.

10. The method of claim 1, further comprising:
relaying only data on the second communication link to the relay UE that is assigned by the joint grant for transmission of the data by the relay UE to the base station over the third communication link.

11. The method of claim 1, further comprising:
allowing only the granted resources on the second communication link to be used for data belonging to corresponding logical channels (LCHs) of the second communication link.

12. A user equipment (UE) configured for wireless communication, comprising:
a processor;
a memory communicatively coupled to the processor; and
a transceiver communicatively coupled to the processor,
wherein the processor and the memory are configured to:
receive a joint grant from a base station over a first communication link, the joint grant comprising:
a first resource assignment portion for assigning resources for transmissions between the UE and a relay user equipment (UE) over a second communication link; and
a second resource assignment portion for assigning uplink resources for transmissions between the relay UE and the base station over a third communication link; and
establish the second communication link based on the first resource assignment portion; and
send the second resource assignment portion to the relay UE via the third communication link.

13. A method for wireless communication at a base station in a wireless communication network, the method comprising:
sending a joint grant from the base station to a user equipment (UE) over a first communication link, the joint grant comprising:
a first resource assignment portion for assigning resources for transmissions between the UE and a relay user equipment (UE) over a second communication link; and
a second resource assignment portion for assigning uplink resources for transmissions between the relay UE and the base station over a third communication link; and
receiving uplink (UL) communication data from the relay UE via the third communication link.

14. The method of claim 13, wherein the UL communication data is uplink data from the UE relayed by the relay UE.

15. The method of claim 13, further comprising:
the first and third communication links configured according to a first radio access technology (RAT) and the second communication link configured according to a second RAT.

16. The method of claim 15, wherein the first RAT is 5G new radio (NR) technology and second RAT is a sidelink (SL) technology.

17. The method of claim 13, wherein the first and third communication links comprise Uu interfaces and the second communication link comprises a sidelink PC5 interface.

18. The method of claim 13, further comprising:
configuring the second resource assignment portion to assign uplink resources for transmissions between at least one additional relay UE concatenated with the relay UE and configured to communicate with the relay UE via an additional second communication link and to relay communications data from the relay UE to base station via the third communication link.

19. The method of claim 13, wherein the joint grant is further configured as a two-stage grant wherein the first resource assignment portion is sent at a first time and the second resource assignment portion is sent at a second time.

20. The method of claim 13, wherein the first and second resource assignment portions of the joint grant are sent from a media access control (MAC) component of the base station to a corresponding MAC component of the UE.

21. The method of claim 20, wherein at least the second resource assignment portion of the joint grant is sent from the MAC component of the base station to a sidelink MAC component of the relay UE via the corresponding MAC component of the UE.

22. The method of claim 13, further comprising:
configuring the first resource assignment and the second resource assignment of the joint grant to only allow the relaying of data on the second and third communication links that are assigned by the joint grant.

23. The method of claim 13, further comprising:
configuring the first resource assignment and the second resource assignment of the joint grant to only allow the granted resources on the second and third communication links to be used for data belonging to corresponding logical channels (LCHs) of the second and third communication links.

24. A method for wireless communication at a relay user equipment (UE) in a wireless communication network, the method comprising:
receiving in the relay UE at least a first portion of a joint grant from a UE over a sidelink communication link, wherein the joint grant is transmitted by a base station to the UE over a first communication link and comprises a sidelink resource assignment portion for assigning resources for transmissions between the UE and the relay UE over the sidelink communication link, and the first portion comprises a resource assignment portion for assigning uplink resources for transmissions between the relay UE and the base station over a second communication link; and
establishing the second communication link between the relay UE and the base station based on the first portion of the joint grant.

25. The method of claim 24, further comprising:
relaying uplink (UL) communication data received from the UE via the sidelink communication link to the base station via the second communication link.

26. The method of claim 24, wherein the first and second communication links comprise Uu interfaces and the sidelink communication link comprises a sidelink PC5 interface.

27. The method of claim 24, further comprising:
configuring the resource assignment portion to assign uplink resources for transmissions between at least one additional relay UE concatenated with the relay UE and configured to communicate with the relay UE via an additional sidelink communication link and to relay communications data from the UE to the base station via the second communication link.

28. The method of claim 24, wherein the joint grant is further configured as a two-stage grant wherein the sidelink resource assignment portion is received at a first time and the resource assignment portion is received at a second time.

29. The method of claim 24, wherein the resource assignment portion of the joint grant is received by a media access control (MAC) component of the relay UE.

30. The method of claim 24, further comprising:
allowing only the granted resources on the second communication link to be used for data belonging to corresponding logical channels (LCHs) of the second communication link.
